(19) United States
(12) Patent Application Publication
(10) Pub. No.: US 2022/0082398 A1
(43) Pub. Date: Mar. 17, 2022

(54) Method and Device for Measuring Driving Route Familiarity

(71) Applicant: Guangzhou Automobile Group Co., Ltd., Guangzhou (CN)

(72) Inventors: Wan CHEN, Guangzhou (CN); Yonggang XU, Guangzhou (CN)

(21) Appl. No.: 17/023,417

(22) Filed: Sep. 17, 2020

(51) Int. Cl. G01C 21/34; G08G 1/01; G08G 1/16

(52) U.S. Cl. CPC G01C 21/3484; G08G 1/16; G08G 1/0129

(57) ABSTRACT

Provided are a method and device for measuring driving route familiarity. The method includes the following steps: extracting historical driving routes from user historical driving data; calculating information entropy for the user according to distribution of the driving routes; determining driving route familiarity for the user based on the information entropy.

### TECHNICAL FIELD

The present disclosure relates to the field of automobile driving, and particularly to a method and device for measuring driving route familiarity.

### BACKGROUND

Some drivers drive from or to a certain small set of locations (e.g., home and office), which means less uncertainties in routes and therefore the drivers may be more familiar with the routes. Some other drivers, however, often drive from or to new locations that they never visited before, which means more uncertainties in routes and therefore they may be less familiar with their routes. The route familiarity in driving can be used as a determination factor of collision risks.

It is to be noted that the information disclosed in this background of the disclosure is only for enhancement of understanding of the general background of the present disclosure and should not be taken as an acknowledgement or any form or suggestion that this information forms the prior art already known to a person skilled in the art.

### SUMMARY

Embodiments of the present disclosure provide method and device for measuring driving route familiarity, and intend to solve the problem of driving uncertainty.

According to one aspect of the present disclosure, a method for measuring driving route familiarity is provided. The method comprises the following steps: extracting historical driving routes from user historical driving data; calculating information entropy for the user according to distribution of the driving routes; determining driving route familiarity for the user based on the information entropy.

In an exemplary embodiment, each of the historical driving routes is defined by the starting and ending locations of each driving route.

In an exemplary embodiment, the information entropy is calculated by the following formula:

$$H = - {\sum }_{i = 1}^{n} {p}_{i} {log}_{2} {p}_{i}$$

where pᵢ represents the probability of the i^{th} route.

In an exemplary embodiment, wherein pᵢ is calculated by the following formula:

$${p}_{i} = \frac{\# {Trip}_{i}}{{\sum }_{j = 1}^{n} \# {Trip}_{j}} ,$$

where #Tripᵢ represents the frequency of the i^{th} route Tripᵢ in the history.

In an exemplary embodiment, determining driving route familiarity for the user based on the information entropy comprises: determining the driving route familiarity by normalizing the information entropy.

In an exemplary embodiment, wherein familiarity is defined by normalizing the information entropy according to the following formula:

$$Familiarity = exp ( - \frac{H}{σ} ) ,$$

where σ is a normalization factor.

In an exemplary embodiment, wherein the value of the driving route familiarity is in (0, 1], and when the information entropy approaches infinite, the driving route familiarity approaches zero, when the information entropy is 0, the driving route familiarity is 1.

In an exemplary embodiment, wherein extracting historical driving routes from user historical driving data comprises: extracting the historical driving routes from user historical driving data within a preset period of time.

In an exemplary embodiment, after determining the driving route familiarity for the user based on the information entropy, the method further comprises: classifying users into different groups based on the driving route familiarity of the users, and the groups at last comprises: relatively conservative users and relatively explorative users.

In an exemplary embodiment, after determining the driving route familiarity for the user based on the information entropy, the method further comprises: predicting the likelihood of collision risk base on the driving route familiarity of the users, wherein the users with lower driving route familiarity tend to have higher probabilities to get involved in collisions.

In an exemplary embodiment, after determining the driving route familiarity for the user based on the information entropy, the method further comprises: providing intelligent service or recommendation based on the driving route familiarity of the user.

According to another aspect of the present disclosure, a device for measuring driving route familiarity is also provided. The device includes: extraction module, configured to extract historical driving routes from user historical driving data; calculation module, configured to calculate information entropy for the user according to distribution of the driving routes; determination module, configured to determine driving route familiarity for the user based on the information entropy.

According to another aspect of the present disclosure, a non-volatile computer readable storage medium is also provided. A program is stored in the non-volatile computer readable storage medium, and the program is configured to be executed by a computer to perform the steps of methods in above-mentioned embodiments.

According to another aspect of the present disclosure, a device for measuring driving route familiarity is provided, and the device includes a processor and a memory, the processor being configured to execute a program stored in the memory to implement the steps of the method in above-mentioned embodiments.

In the above-mentioned embodiments of the present disclosure, provide a general data-driven approach to mine and extract driving routes from user driving history, and use the Information Entropy to measure driving familiarity based on the holistic distribution of the driving routes for each user.

### BRIEF DESCRIPTION OF THE DRAWINGS

The drawings described here are adopted to provide a further understanding to the present disclosure and form a part of the application. Schematic embodiments of the present disclosure and descriptions thereof are adopted to explain the present disclosure and not intended to form limits to the present disclosure. In the drawings:

FIG. 1 is a flowchart of a method for measuring driving route familiarity according to an embodiment of the present disclosure;

FIG. 2 is a flowchart of a method for measuring driving route familiarity according to another embodiment of the present disclosure;

FIG. 3 is a flowchart of a method for measuring driving route familiarity according to another embodiment of the present disclosure;

FIG. 4 is the distribution of the entropy values for some number of drivers according to an embodiment of the present disclosure;

FIG. 5 is a structure block diagram of a device measuring driving route familiarity according to another embodiment of the present disclosure; and

FIG. 6 is a structure block diagram of device measuring driving route familiarity according to an embodiment of the present disclosure.

### DETAILED DESCRIPTION OF THE EMBODIMENTS

The present disclosure will be described below with reference to the drawings and in combination with the embodiments in detail. It is to be noted that the embodiments in the application and characteristics in the embodiments may be combined without conflicts.

### Embodiment 1

In the present embodiment, a method for measuring driving route familiarity is provided. The method is used to measure driving route familiarity by measuring uncertainties in the statistical distribution of history routes.

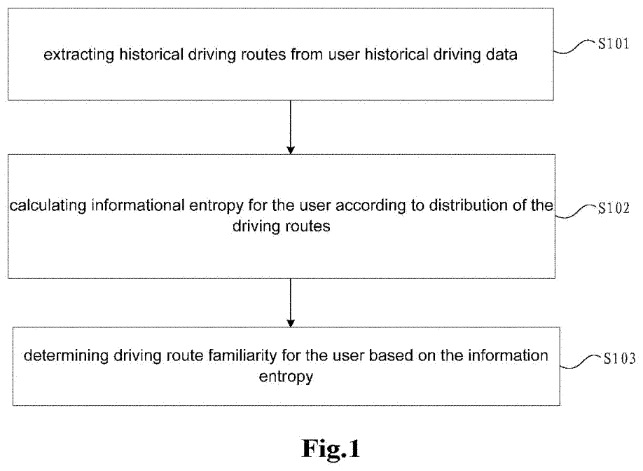

As shown in FIG. 1, the method includes the following steps.

At S101, extracting historical driving routes from user historical driving data.

At S102, calculating information entropy for the user according to distribution of the driving routes.

At S103, determining driving route familiarity for the user based on the information entropy.

In step S101 of the present embodiment, the user historical driving data can be selected from those data within a preset period of time. For example, a one-month window often produces more meaningful results than either a longer or shorter window.

In the present embodiment, each of the historical driving routes can be defined by the starting and ending locations of each driving route.

In step S102 of the present embodiment, the information entropy can be calculated by the following formula:

$$H = - {\sum }_{i = 1}^{n} {p}_{i} {log}_{2} {p}_{i}$$

where pᵢ represents the probability of the i^{th} route, and pᵢ can be calculated by the following formula:

$${p}_{i} = \frac{\# {Trip}_{i}}{{\sum }_{j = 1}^{n} \# {Trip}_{j}} , ,$$

where #Tripᵢ represents the frequency of the i^{th} route Tripᵢ in the history.

In step S103 of the present embodiment, the information entropy can be normalized by the following formula:

$$Familiarity = exp ( - \frac{H}{σ} ) ,$$

where σ is a normalization factor, and the value of the driving route familiarity is in (0, 1], and when the information entropy approaches infinite, the driving route familiarity approaches zero, when the information entropy is 0, the driving route familiarity is 1.

In the present embodiment, after the step S103, the method may further include: classifying users into different groups based on the driving route familiarity of the users, and the groups at last comprises: relatively conservative users and relatively explorative users.

In the present embodiment, after the step S103, the method may further include: predicting the likelihood of collision risk based on the driving route familiarity of the users, wherein the users with lower driving route familiarity tend to have higher probabilities to get involved in collisions.

In the present embodiment, after the step S103, the method may further include: providing intelligent service or recommendation based on the driving route familiarity of the user.

### Embodiment 2

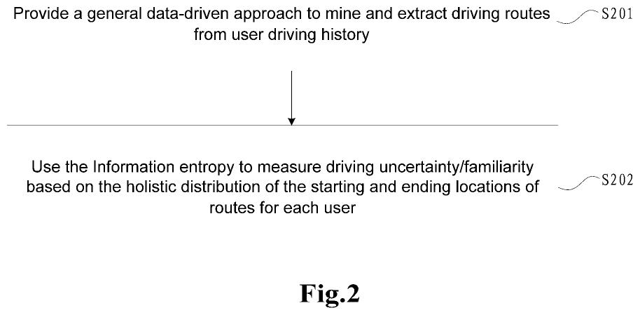

FIG. 2 is a flowchart of method for measuring driving route familiarity according to an embodiment of the present disclosure.

As shown in FIG. 2, the method includes the following steps.

At step 201, provides a general (not relying on any third-party equipment or monitor) data-driven approach to mine and extract driving routes from user driving history;

At step 202, use the Information Entropy to measure driving uncertainty/familiarity based on the holistic distribution of the starting and ending locations of routes for each user.

Entropy is an important concept in information theory. It represents the average rate at which information is produced by a stochastic source of data. The measure of information theory associated with each possible data value is the negative logarithm of the probability mass function for the value. We thus can compute an entropy for each user based on the distribution of his/her history driving routes, using the following Entropy formula:

H=−Σᵢ₌₁ⁿpᵢ log₂ pᵢ (1)

where pᵢ represents the probability of the i^{th} route (defined by both the departure and arrival locations), which is essentially the relative frequency of the route to the total number of all routes for the same user, formally,

$${p}_{i} = \frac{\# {Trip}_{i}}{{\sum }_{j = 1}^{n} \# {Trip}_{j}} , , \qquad ( 2 )$$

where #Tripᵢ represents the frequency of Tripᵢ in the history.

Below is an example of the calculation process, as shown in table 1.

TABLE 1

| Index | Start | End | # of trips | probability |
|---|---|---|---|---|
| 1 | 10 Main Street, | 1 Commercial Street, | 1 | 0.01 |
| | Some City, CA | Some City, CA | | |
| 2 | 2 University Ave, | 5 Mathilda Ave, | 95 | 0.95 |
| | Some City, CA | Some City, CA | | |
| 3 | 6 Second Street, | 10 Main Street, | 4 | 0.04 |
| | Some City, CA | Some City, CA | | |

Based on the above table 1, Entropy of the above vehicle = −0.01 * log₂(0.01) − 0.95 * log₂(0.95) − 0.04 * log₂(0.04) = 0.3224.

In reality, all users do not have the same driving history. For example, some users may have already driven for years, while some other users have only driven for a few weeks. This issue makes the entropy values not comparable across different users. Moreover, the driving behaviors of users may evolve along with the time, and more attention shall be paid to recent driving behaviors than driving behaviors long time ago. Inspired by these two observations, in the present embodiment, it is proposed to normalize the entropy calculation by focusing on the recent driving history. In particular, empirically a one-month window often produces more meaningful results than either a longer or shorter window.

In the present embodiment, let H be the entropy of the vehicle and let σ be the normalization factor. In order to assess the drivers' familiarity, given the above values, one can establish the driver's route familiarity as formula (3):

$$Familiarity = exp ( - \frac{H}{σ} ) \qquad ( 3 )$$

As the entropy increases, the driving familiarity is monotonously decreasing, and vice versa. Moreover, the familiarity score is always in (0, 1]. When the entropy approaches infinite, the driving familiarity will be zero, and when entropy is zero, the driving familiarity is 1.

In the present embodiment, the method has benefits as below:

The computed entropy data can be used to measure route familiarity. In the present embodiment, the familiarity (via entropy) can be defined based on the historical departure-arrival locations of the users, or the familiarity (via entropy) can be defined based on historical routes of the users.

Measuring driving familiarity can classify drivers into different groups. The route familiarity in driving can serve as an important criterion to classify relatively conservative drivers and relatively explorative drivers.

The driving uncertainty/familiarity measured by entropy can be used to predict the likelihood of collision risks. Drivers with higher uncertainty in their routes tend to have higher probabilities to get involved in collisions due to their lower familiarity with the routes.

Based on the driving uncertainty of the users, some intelligent services/recommendations can be provided to the corresponding users. For example, for users with low route uncertainty, we could provide alerts/suggestions when their regular routes have heavy traffic in advance; for users with high route uncertainty, we could recommend or advertise more explorative locations/routes/information to them (e.g., the grand opening of a restaurant).

The familiarity may also be used to detect life style change or job change for the driver of the same vehicle. For example, when a commuter takes on a ridesharing service side job, it will be reflected as a jump in the entropy value as defined in formula (1).

In the present embodiment, a data-driven and mathematical model is created, to analyze the route uncertainties of the users. This model can be used as an factor to predict the driving safety of a vehicle, together with other factors.

### Embodiment 3

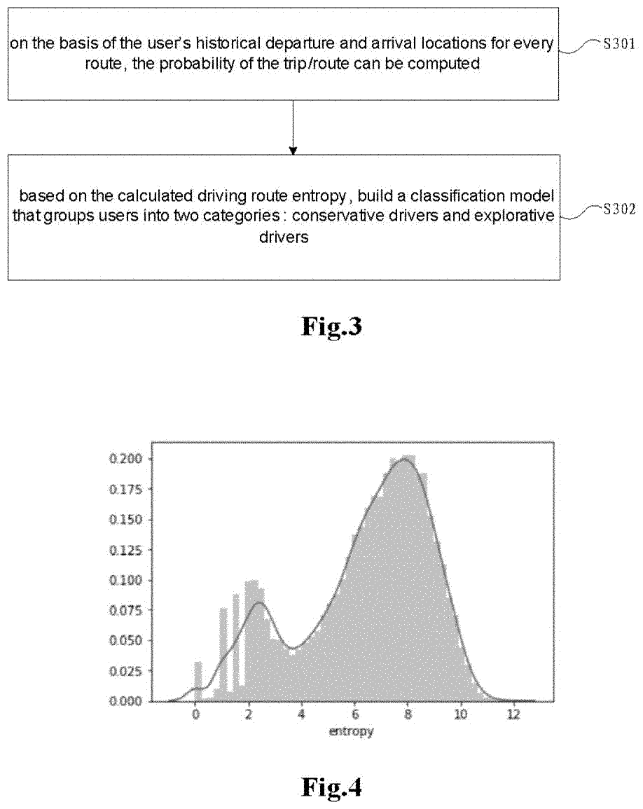

FIG. 3 is a flowchart of method for measuring driving route familiarity according to an embodiment of the present disclosure. As shown in FIG. 3, the method includes the following steps.

At S301, on the basis of the user's historical departure and arrival locations for every trip/route, the probability (i.e., relative frequency) of the trip/route can be computed.

In the present application, based on departure/arrival location distributions, driving route entropy can be calculated by using the formula (1) in above embodiments.

At S302, based on the calculated driving route entropy, build a classification model that groups users into two categories: conservative drivers (i.e., users with certain routes every day) and explorative drivers (users with many ad-hoc routes).

Alternatively, in the present embodiment, the driving route entropy is used as one input feature (or risk factor) to mathematically compute a vehicle's collision likelihood. Supervised machine learning methodologies are applied to quantify the entropy's impact.

For example, FIG. 4 is the distribution of the entropy values for all vehicles. It illustrates an interesting two-peak distribution. As shown in FIG. 4, there are indeed two types of users: low-uncertainty and high-uncertainty, which also demonstrates that “entropy” is a good way to model driving route uncertainty.

In addition, in the present embodiment, another entropy model for route entropy can be created based on the historical routes of user, instead of historical departure-arrival location pairs. It would provide other insights about route uncertainty.

Note that with little change, the entropy model provided by the present embodiment can be modified to measure other types of driving uncertainty, such as driving time uncertainty (some users may only drive in the morning and evening every day, while some other users may drive anytime), charging behavior uncertainty (some users may only charge their cars when the electricity/gas has fell below a particular level, while some other users may do charging randomly), home departure/arrival uncertainty, etc.

### Embodiment 4

In the present embodiment, a device for measuring driving route familiarity is also provided. The device is configured to implement the abovementioned embodiments with preferred implementation modes.

Note that what has been described will not be elaborated. For example, term “module”, used below, may be a combination of software and/or hardware realizing a predetermined function. Although the device described in the following embodiment is preferably implemented by the software, implementation by the hardware or the combination of the software and the hardware is also possible and conceivable.

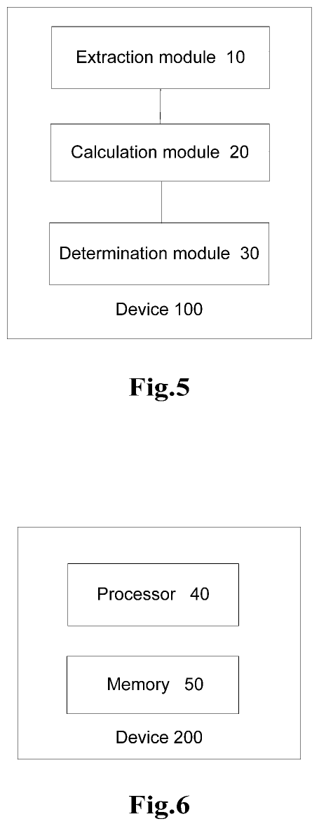

FIG. 5 is a structure block diagram of a device for measuring driving route familiarity according to an embodiment of the present disclosure. As shown in FIG. 5, the device 100 includes an extraction module 10, a calculation module 20 and a determination module 30.

The extraction module 10 is configured to extract historical driving routes from user historical driving data. The calculation module 20 is configured to calculate information entropy for the user according to distribution of the driving routes. The determination module 30 is configured to determine driving route familiarity for the user based on the information entropy.

### Embodiment 5

According to the present embodiment, a non-volatile computer readable storage medium is provided, a program is stored in the non-volatile computer readable storage medium, and the program is configured to be executed by a computer to perform the following steps.

S1, extracting historical driving routes from user historical driving data.

S2, calculating information entropy for the user according to distribution of the driving routes.

S3, determining driving route familiarity for the user based on the information entropy.

In an example embodiment, the storage medium may include, but not limited to, various media capable of storing program codes such as a U disk, a ROM, a RAM, a mobile hard disk, a magnetic disk or an optical disk.

### Embodiment 6

According to the present embodiment, a device is provided. As shown in FIG. 6, the device 200 includes a processor 40 and a memory 50, the processor 40 being configured to execute a program stored in the memory 50 to implement the steps of the method in above-mentioned embodiments.

It is apparent that those skilled in the art should know that each module or each step of the present disclosure may be implemented by a universal computing device, and the modules or steps may be concentrated on a single computing device or distributed on a network formed by a plurality of computing devices, and may in an embodiment be implemented by program codes executable for the computing devices, so that the modules or the steps may be stored in a storage device for execution with the computing devices, the shown or described steps may be executed in sequences different from those described here in some circumstances, or may form individual integrated circuit module respectively, or multiple modules or steps therein may form a single integrated circuit module for implementation. Therefore, the present disclosure is not limited to any specific hardware and software combination.

The above is only the exemplary embodiments of the present disclosure and not intended to limit the present disclosure. For those skilled in the art, the present disclosure may have various modifications and variations. Any modifications, equivalent replacements, improvements and the like made within the spirit and principle of the present disclosure shall fall within the scope of protection of the present disclosure.

What is claimed is:

1. A method for measuring driving route familiarity, comprising:
extracting historical driving routes from user historical driving data;
calculating information entropy for the user according to distribution of the driving routes;
determining driving route familiarity for the user based on the information entropy.

2. The method according to claim 1, wherein each of the historical driving routes is defined by the starting and ending locations of each driving route.

3. The method according to claim 2, wherein the information entropy is calculated by the following formula:
H=−Σᵢ₌₁ⁿpᵢ log₂ pᵢ
where pᵢ represents the probability of the i^{th} route.

4. The method according to claim 3, wherein pᵢ is calculated by the following formula:
$${p}_{i} = \frac{\# {Trip}_{i}}{{\sum }_{j = 1}^{n} \# {Trip}_{j}}$$
where #Tripᵢ represents the frequency of the i^{th} route Tripᵢ in the history.

5. The method according to claim 1, determining driving route familiarity for the user based on the information entropy comprises:
determining the driving route familiarity by normalizing the information entropy.

6. The method according to claim 1, wherein the information entropy is normalized by the following formula:
$$Familiarity = exp ( - \frac{H}{σ} ) ,$$
where σ is a normalization factor.

7. The method according to claim 6, wherein the value of the driving route familiarity is in (0, 1], and when the information entropy approaches infinite, the driving route familiarity approaches zero, when the information entropy is 0, the driving route familiarity is 1.

8. The method according to claim 1, wherein extracting historical driving routes from user historical driving data comprises:
extracting the historical driving routes from user historical driving data within a preset period of time.

9. The method according to claim 1, after determining the driving route familiarity for the user based on the information entropy, the method further comprises:
classifying users into different groups based on the driving route familiarity of the users, and the groups at last comprises: relatively conservative users and relatively explorative users.

10. The method according to claim 1, after determining the driving route familiarity for the user based on the information entropy, the method further comprises:
predicting the likelihood of collision risk base on the driving route familiarity of the users, wherein the users with lower driving route familiarity tend to have higher probabilities to get involved in collisions.

11. The method according to claim 1, after determining the driving route familiarity for the user based on the information entropy, the method further comprises:
providing intelligent service or recommendation based on the driving route familiarity of the user.

12. A device for measuring driving route familiarity, comprising:
extraction module, configured to extract historical driving routes from user historical driving data;
calculation module, configured to calculate information entropy for the user according to distribution of the driving routes;
determination module, configured to determine driving route familiarity for the user based on the information entropy.

13. A non-volatile computer readable storage medium, in which a program is stored, the program is configured to be executed by a computer to perform the method as claimed in claim 1.

14. A device for measuring driving route familiarity, comprising a processor and a memory, the processor being configured to execute a program stored in the memory to implement the steps of the method as claimed in claim 1.

15. A device for measuring driving route familiarity, comprising a processor and a memory, the processor being configured to execute a program stored in the memory to implement the steps of the method as claimed in claim 2.

16. A device for measuring driving route familiarity, comprising a processor and a memory, the processor being configured to execute a program stored in the memory to implement the steps of the method as claimed in claim 3.

17. A device for measuring driving route familiarity, comprising a processor and a memory, the processor being configured to execute a program stored in the memory to implement the steps of the method as claimed in claim 4.

18. A device for measuring driving route familiarity, comprising a processor and a memory, the processor being configured to execute a program stored in the memory to implement the steps of the method as claimed in claim 5.

19. A device for measuring driving route familiarity, comprising a processor and a memory, the processor being configured to execute a program stored in the memory to implement the steps of the method as claimed in claim 6.

20. A device for measuring driving route familiarity, comprising a processor and a memory, the processor being configured to execute a program stored in the memory to implement the steps of the method as claimed in claim 7.
